(19) United States
(12) Patent Application Publication
(10) Pub. No.: US 2025/0284027 A1
(43) Pub. Date: Sep. 11, 2025

(54) METHOD FOR CHARACTERIZING A GEOLOGICAL RESERVOIR OF INTEREST

(71) Applicants: TotalEnergies OneTech, COURBEVOIE (FR); UNIVERSITE TOULOUSE II, TOULOUSE (FR); Institut National Polytechnique de Toulouse, TOULOUSE (FR); Centre national de la recherche scientifique, PARIS (FR); UNIVERSITE TOULOUSE III - PAUL SABATIER, TOULOUSE CEDEX 9 (FR)

(72) Inventors: Daniel BUSBY, PAU CEDEX (FR); Abderrahmane YEWGAT, PAU CEDEX (FR); Max CHEVALIER, TOULOUSE CEDEX 9 (FR); Corentin LAPEYRE, TOULOUSE CEDEX 9 (FR)

(73) Assignees: TotalEnergies OneTech, COURBEVOIE (FR); UNIVERSITE TOULOUSE II, TOULOUSE (FR); Institut National Polytechnique de Toulouse, TOULOUSE (FR); Centre national de la recherche scientifique, PARIS (FR); UNIVERSITE TOULOUSE III - PAUL SABATIER, TOULOUSE CEDEX 9 (FR)

(21) Appl. No.: 18/862,770

(22) PCT Filed: May 6, 2022
(86) PCT No.: PCT/IB2022/000259

§ 371 Date: Nov. 4, 2024

(51) Int. Cl. G01V 20/00; G06F 30/27

(52) U.S. Cl. CPC G01V 20/00; G06F 30/27

(57) ABSTRACT

The present invention concerns a method for characterizing a geological reservoir of interest, the method comprising the training of an artificial intelligence model according to a training technique applied to a training database to obtain a trained model, the trained model predicting the spatiotemporal evolution over a period of time of flow parameter(s) for a geological reservoir of interest when a set of input data relative to the geological reservoir of interest are inputted in the trained model, the set of input data comprising initial values of each flow parameter for the geological reservoir of interest and values of geological features for said geological reservoir of interest, the artificial intelligence model being a neural network having neural parameters.

### CROSS REFERENCE TO RELATED APPLICATIONS

The present application is a U.S. National Phase Application under 35 U.S.C. § 371 of International Patent Application No. PCT/IB2022/000259 filed May 6, 2022. The entire contents of which are hereby incorporated by reference.

### FIELD OF THE INVENTION

The present invention concerns a method for characterizing a geological reservoir of interest. The present invention also concerns an associated computer program product. The present invention also relates to an associated readable information carrier.

### BACKGROUND

An aquifer is an example of a geological reservoir. An aquifer, also called water and/or hydrocarbon-bearing reservoir is an underground layer of water and/or hydrocarbon-bearing permeable rock, rock fractures or unconsolidated materials (gravel, sand, or silt). An oil reservoir is a particular type of aquifer.

History matching consists in finding the geological parameters of a reservoir model allowing to reproduce the dynamic data (hydrocarbon flow and pressures) observed on the field. To do this, an inverse problem is solved.

However, solving the inverse problem requires the evaluation of a large number of flow simulations which can be very expensive in terms of computing time. This is why an history matching can take several months.

Indeed, classical simulation approaches are based on the resolution of partial differential equations that govern fluid flow in a porous medium. This resolution of PDEs quickly becomes very expensive (in computation time) when the geological model is of large size (hundreds of thousands/millions of cells). In addition, this resolution of PDEs must be performed each time the geological model is changed.

Many approaches have been proposed to build predictive reservoir models faster than classical approaches. Among these approaches we can distinguish several categories:
Response surface approaches aim at building proxies of the production curves of each well/observed quantity as a function of a small number of macro or global parameters. These approaches are interpolation methods: in general a different model is built for each observed data or time series of data.
Reduced physics approaches: in these approaches the geological model is simplified by drastically reducing the number of model parameters (for example by doing a very rough upscaling of the geological model). The physical equations can also be simplified. The resulting simulation models can be very fast, but ultimately do not allow for the inference of very precise geological parameters (which may be necessary to make decisions on the setting of new wells for example).
Pure machine learning approaches: these approaches only work in cases where the number of observed data is very large (several hundred of wells). They allow production forecasts to be made, generally for existing wells, while for new wells the results are generally very uncertain.

### SUMMARY

Hence, there exists a need for a method enabling to predict faster and in a reliable way the flow parameters of a geological reservoir of interest.

To this end, the invention relates to a method for characterizing a geological reservoir of interest, the method comprising the following steps which are computer-implemented:
obtaining a physics model defining a relation between flow parameter(s) of a given geological reservoir at a timestep and flow parameter(s) of the given geological reservoir at the previous timestep for a plurality of timesteps, the physics model being based on elementary functions specific to each timestep so that the flow parameter at a timestep depends on the elementary functions corresponding to said flow parameter at said timestep and on at least the corresponding flow parameter obtained at the previous timestep,
obtaining a training database relative to known possible geological realizations of a given geological reservoir, the training database comprising for each geological realization a set of data comprising:
   a past spatiotemporal evolution of flow parameter(s) for said geological reservoir,
   values of at least one geological feature for said geological reservoir,
training an artificial intelligence model according to a training technique applied to the training database to obtain a trained model, the trained model predicting the spatiotemporal evolution over a period of time of flow parameter(s) for a geological reservoir of interest when a set of input data relative to the geological reservoir of interest are inputted in the trained model, the set of input data comprising initial values of each flow parameter for the geological reservoir of interest and values of each geological feature for said geological reservoir of interest, the artificial intelligence model being a neural network having neural parameters, the training technique enabling to approximate the elementary functions of the physics model for each timestep by setting the values of the neural parameters for each timestep so that some values are specific for each timestep,
obtaining a set of input data for a geological reservoir of interest, and
characterizing the geological reservoir of interest by operating the trained model for predicting the spatiotemporal evolution of each flow parameter for the geological reservoir of interest on the basis of the obtained set of input data.

The method according to the invention may comprise one or more of the following features considered alone or in any combination that is technically possible:
during the training step, the setting of the values of the neural parameters for each timestep is carried out so that some values are common for all the timesteps;
   during the training step, the values of the neural parameters are set so as to minimize a cost function, the cost function describing the differences between the spatiotemporal evolutions of flow parameter(s) of the training database and the corresponding spatiotemporal evolutions of flow parameter(s) obtained with the artificial intelligence model;
   the artificial intelligence model is a convolutional neural network;
   at least a geological feature of the geological reservoir is chosen among the porosity, the permeability, the net to gross, the fault transmissibility tensor, the residual oil/water saturations and the changes in the boundary conditions related to the well controls;
   at least a flow parameter is chosen in the group consisting in: a fluid saturation, a gas saturation, a fluid pressure and a gas pressure;
   the physics model is such that the flow parameter at a timestep depends on the corresponding elementary functions at said timestep, on the corresponding flow parameter obtained at the previous timestep and on at least another flow parameters obtained at the previous timestep;
   at least two flow parameters are considered when implementing the method, the two flow parameters being a saturation and a pressure of an element in the considered geological reservoir, the physics model being described by the following equations:

$$\hat{P} ( Δ t , x , y , z , m ) = \hat{P} ( Δ t - 1 , x \pm Δ x , y \pm Δ y , z \pm Δ z , m ) - {g}_{t} ( m , \hat{P} ( Δ t - 1 , x \pm Δ x , y \pm Δ y , z \pm Δ z , m ) , \hat{S} ( Δ t - 1 , x \pm Δ x , y \pm Δ y , z \pm Δ z , m ) )$$

$$\hat{S} ( Δ t , x , y , z , m ) = \hat{S} ( Δ t - 1 , x \pm Δ x , y \pm Δ y , z \pm Δ z , m ) - {f}_{t} ( m , \hat{P} ( Δ t - 1 , x \pm Δ x , y \pm Δ y , z \pm Δ z , m ) , \hat{S} ( Δ t - 1 , x \pm Δ x , y \pm Δ y , z \pm Δ z , m ) )$$

$$P ( Δ {t}_{0} , x , y , z , m ) = P 0$$

$$S ( Δ {t}_{0} , x , y , z , m ) = S 0$$

Where:
m corresponds to the geological features of a geological reservoir,
\hat{P}(Δt, x, y, z, m) is the predicted pressure of the element at timestep Δt in the region of space defined by the spatial coordinates for a geological reservoir having the geological features m,
\hat{P}(Δt−1, x±Δx, y±Δy, z±Δz, m) is the predicted pressure of the element at timestep Δt−1 in the region of space defined by the spatial coordinates (x±Δx, y±Δy, z±Δz) for a geological reservoir having the geological features m,
Ŝ(Δt, x, y, z, m) is the predicted saturation of the element at timestep Δt in the region of space defined by the spatial coordinates for a geological reservoir having the geological features m,
Ŝ(Δt−1, x±x, y±Δy, z±Δz, m) is the predicted saturation of the element at timestep Δt−1 in the region of space defined by the spatial coordinates (x±Δx, y±Δy, z±Δz) for a geological reservoir having the geological features m,
P0 is the pressure of the element at the initial timestep Δt₀ in the region of space defined by the spatial coordinates for a geological reservoir having the geological features m,
S0 is the saturation of the element at the initial timestep Δt₀ in the region of space defined by the spatial coordinates for a geological reservoir having the geological features m,
gₜ is an elementary function at timestep Δt for the pressure, and
fₜ is an elementary function at timestep Δt for the saturation;
each set of data of the training database are simulated data obtained using a simulator based on partial differential equations;
the characterizing step comprises:
   obtaining a measured spatiotemporal evolution of the flow parameters for the geological reservoir of interest over the same period of time than the trained model, and
   repeating the operation of the trained model for different values of the geological feature(s) of the geological reservoir of interest in the input data until the spatiotemporal evolution of the flow parameters obtained with the trained model matches the measured spatiotemporal evolution of the flow parameters,
   the value(s) of the geological feature(s) in the input data corresponding to the matching enabling to characterize the geological reservoir of interest;
at least a flow parameter is a gas saturation, the characterizing step comprising:
repeating the operation of the trained model for different values of the geological feature(s) of the geological reservoir of interest in the input data, and
evaluating the probability that the gas goes out of the geological reservoir on the basis of the spatiotemporal evolution of said gas saturation obtained for the different values of the geological feature(s).

The invention also relates to a computer program product comprising a readable information carrier having stored thereon a computer program comprising program instructions, the computer program being loadable onto a data processing unit and causing a method as previously described to be carried out when the computer program is carried out on the data processing unit.

The invention also relates to a readable information carrier on which a computer program product as previously described is stored.

### BRIEF DESCRIPTION OF THE DRAWINGS

The invention will be easier to understand in view of the following description, provided solely as an example and with reference to the appended drawings in which:

FIG. 1 is a schematic view of an example of a calculator allowing the implementation of a method for characterizing a geological reservoir of interest,

FIG. 2 is a flowchart of an example of implementation of a method for characterizing a geological reservoir of interest, and

FIG. 3 is a schematic representation of an example of implementation of the training step of the method, and

FIG. 4 is a schematic representation of an example of operation of the trained model of the method.

### DETAILED DESCRIPTION

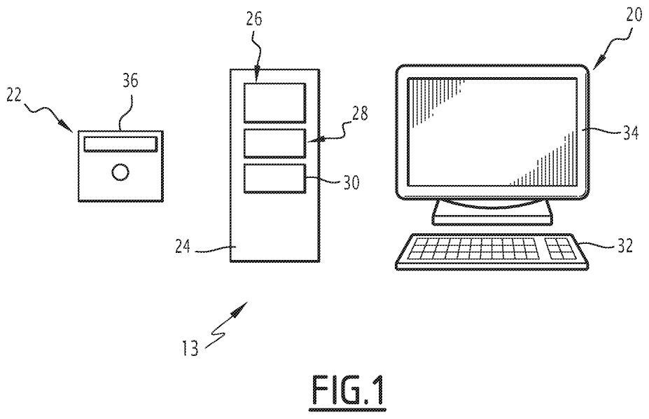

An example of a calculator 20 and of a computer program product 22 are illustrated on FIG. 1.

The calculator 20 is preferably a computer.

More generally, the calculator 20 is a computer or computing system, or similar electronic computing device adapted to manipulate and/or transform data represented as physical, such as electronic, quantities within the computing system's registers and/or memories into other data similarly represented as physical quantities within the computing system's memories, registers or other such information storage, transmission or display devices.

The calculator 20 interacts with the computer program product 22.

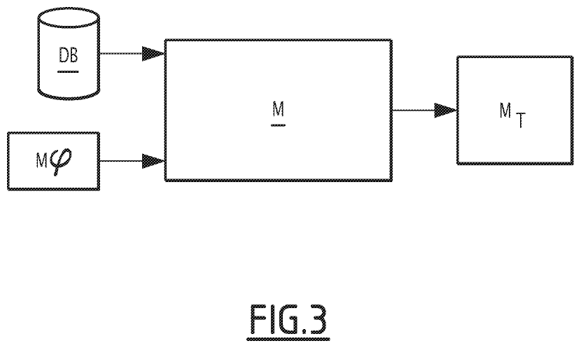

As illustrated on FIG. 1, the calculator 20 comprises a processor 24 comprising a data processing unit 26, memories 28 and a reader 30 for information media. In the example illustrated on FIG. 3, the calculator 20 comprises a human machine interface 32, such as a keyboard, and a display 34.

The computer program product 22 comprises an information medium 36.

The information medium 36 is a medium readable by the calculator 20, usually by the data processing unit 26. The readable information medium 36 is a medium suitable for storing electronic instructions and capable of being coupled to a computer system bus.

By way of example, the information medium 36 is a USB key, a floppy disk or flexible disk (of the English name “Floppy disc”), an optical disk, a CD-ROM, a magneto-optical disk, a ROM memory, a memory RAM, EPROM memory, EEPROM memory, magnetic card or optical card.

On the information medium 36 is stored the computer program 22 comprising program instructions.

The computer program 22 is loadable on the data processing unit 26 and is adapted to entail the implementation of a method for characterizing a geological reservoir of interest, when the computer program 22 is loaded on the processing unit 26 of the calculator 20.

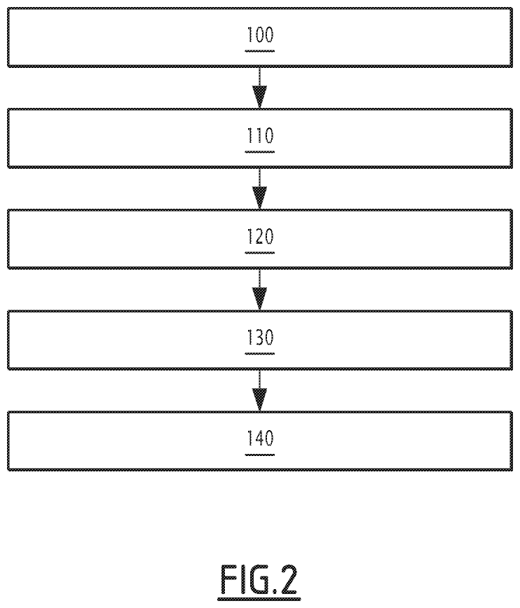

A method for characterizing a geological reservoir of interest in an area of interest, will now be described with reference to FIGS. 2 to 4.

In an example, the geological reservoir of interest is a reservoir of hydrocarbon corresponding to one or several drilling wells. The area of interest is a hydrocarbon field. A field is an area where a large amount of hydrocarbons is buried and an attempt to extract it can be made by drilling wells. A field typically extends over several kilometers, allowing for several wells in one field.

The characterization method enables to characterize a geological reservoir of interest, in particular by predicting the spatio-temporal evolution of flow parameters P_{F} for this geological reservoir of interest. The flow parameters P_{F} are for example the saturation or the pressure of an element in the geological reservoir.

The characterization method comprises a step 100 of obtaining a physics model Mφ. The obtaining step 100 is implemented by the calculator 10 in interaction with the computer program product 12, that is to say is implemented by a computer.

The physics model Mφ defines a relation between flow parameter(s) P_{F} of a given geological reservoir at a timestep Δt and flow parameter(s) P_{F} of the given geological reservoir at the previous timestep Δt−1 for a plurality of timesteps.

The physics model Mφ is relative to at least one flow parameter P_{F}. In an example of embodiment, the physics model Mφ is relative to two flow parameters P_{F} which are a saturation and a pressure of an element in the considered geological reservoir. The element is, for example, a fluid (oil, water) or a gas.

More specifically, the physics model Mφ is based on elementary functions fₜ, gₜ which are specific to each timestep (and unknown). The elementary functions fₜ, gₜ ensure the simulation from one moment to the next. Hence, the flow parameter P_{F} at a timestep Δt depends on the elementary functions fₜ, gₜ corresponding to said flow parameter P_{F} at said timestep Δt and on at least the corresponding flow parameter P_{F} obtained at the previous timestep Δt−1.

Preferably, the physics model Mφ is such that the flow parameter P_{F} at a timestep Δt depends on the corresponding elementary functions fₜ, gₜ at said timestep Δt, on the corresponding flow parameter P_{F} obtained at the previous timestep Δt−1 and on at least another flow parameters P_{F} obtained at the previous timestep Δt−1. In this case, the considered flow parameters P_{F} are interdependent.

Preferably, the geological reservoir is divided into space regions (volume), each space region corresponding to a value of each flow parameter P_{F}, and the relations described above applied for each space region. Preferably, when the physics model Mφ is relative to two flow parameters P_{F} which are a saturation and a pressure of an element in the considered geological reservoir, the physics model Mφ is described by the following equations:

$$\hat{P} ( Δ t , x , y , z , m ) = \hat{P} ( Δ t - 1 , x \pm Δ x , y \pm Δ y , z \pm Δ z , m ) - {g}_{t} ( m , \hat{P} ( Δ t - 1 , x \pm Δ x , y \pm Δ y , z \pm Δ z , m ) , \hat{S} ( Δ t - 1 , x \pm Δ x , y \pm Δ y , z \pm Δ z , m ) )$$

$$\hat{S} ( Δ t , x , y , z , m ) = \hat{S} ( Δ t - 1 , x \pm Δ x , y \pm Δ y , z \pm Δ z , m ) - {f}_{t} ( m , \hat{P} ( Δ t - 1 , x \pm Δ x , y \pm Δ y , z \pm Δ z , m ) , \hat{S} ( Δ t - 1 , x \pm Δ x , y \pm Δ y , z \pm Δ z , m ) )$$

$$P ( Δ {t}_{0} , x , y , z , m ) = P 0$$

$$S ( Δ {t}_{0} , x , y , z , m ) = S 0$$

Where:
m corresponds to the geological features of a geological reservoir (geological model of the geological reservoir) and is also dependent of the spatial position x, y, z,
\hat{P}(Δt, x, y, z, m) is the predicted pressure of the element at timestep Δt in the region of space defined by the spatial coordinates (x, y, z) for a geological reservoir having the geological features m,
\hat{P}(Δt−1, x±Δx, y±Δy, z±Δz, m) is the predicted pressure of the element at timestep Δt−1 in the region of space defined by the spatial coordinates (x±Δx, y±Δy, z±Δz) for a geological reservoir having the geological features m,
Ŝ(Δt, x, y, z, m) is the predicted saturation of the element at timestep Δt in the region of space defined by the spatial coordinates (x, y, z) for a geological reservoir having the geological features m,
Ŝ(Δt−1, x±Δx, y±Δy, z±Δz, m) is the predicted saturation of the element at timestep Δt−1 in the region of space defined by the spatial coordinates (x±Δx, y±Δy, z±Δz) for a geological reservoir having the geological features m,
P0 is the pressure of the element at the initial timestep Δt₀ in the region of space defined by the spatial coordinates (x, y, z) for a geological reservoir having the geological features m,
S0 is the saturation of the element at the initial timestep Δt₀ in the region of space defined by the spatial coordinates (x, y, z) for a geological reservoir having the geological features m,
gₜ is an elementary function at timestep Δt for the pressure, and
fₜ is an elementary function at timestep Δt for the saturation.

Typically, the geological reservoir is divided in cells by a grid and the position x, y, z corresponds to the coordinates of each cell. This division in cells corresponds to a spatial discretization of the geological reservoir. The details of this spatial discretization (cells shape and position) are not an input to our model, however the proximity of the cells is used for the construction of the function fₜ and gₜ by the deep learning algorithm which consider each cell identical as pixel of an image. Deep learning methods in fact are based on convolutions with some spatial filters composed of a fixed number of cells in x,y,z directions.

In this last example, the considered flow parameters P_{F} are interdependent. i.e. to have the pressure at time t+1 there is a need of the pressure and saturation at the time before t.

In this last example, the geological features of the geological reservoir defining the geological model are the porosity of the geological reservoir and the permeability of the geological reservoir.

In the general case any additional parameter that will affect the fluid can be considered as a geological feature, as for instance, the net to gross, the fault transmissibility tensor, the residual oil/water saturations and the changes in the boundary conditions related to the well controls (bottom hole pressure or total fluid rates for each injector and producer well).

The net to gross is the percentage of the volume of the cell which is clayey (no fluid).

The fault transmissibility tensor is relative to a fault between two adjacent cells.

The residual oil/water saturation is relative to the relative permeability and expresses the fact that a certain amount of oil/water cannot be moved out of the geological reservoir and will stay in the geological reservoir.

The boundary conditions are relative to the operations of operators on wells (opening of the wells, injection of water in wells).

The characterization method comprises a step 110 of obtaining a training database DB relative to a plurality of known possible geological realizations of a given geological reservoir. The obtaining step 110 is implemented by the calculator 10 in interaction with the computer program product 12, that is to say is implemented by a computer.

The training database DB comprises for each known geological realization of the geological reservoir a set of data comprising:
a past spatiotemporal evolution of flow parameter(s) P_{F} for said geological reservoir (for each space region or grid cell), and
values for each geological feature of said geological reservoir, each value corresponding to a space region or grid cell of the geological reservoir.

The past spatiotemporal evolution of each flow parameter P_{F} describes the spatiotemporal evolution of said flow parameter P_{F}, timestep by timestep, over a given temporal period.

Preferably, at least a geological feature of the geological reservoir is chosen among the porosity and the permeability (for each spatial region of the geological reservoir).

Preferably, each set of data of the training database DB are simulated data obtained using a simulator based on partial differential equations.

The characterization method comprises a step 120 of training an artificial intelligence model M. The training step 120 is implemented by the calculator 10 in interaction with the computer program product 12, that is to say is implemented by a computer.

The artificial intelligence model M is trained according to a training technique applied to the training database DB to obtain a trained model M_{T}.

The trained model M_{T} predicts at its output the spatiotemporal evolution over a period of time of flow parameter(s) P_{F} for a geological reservoir of interest when a set of input data Di, relative to the geological reservoir of interest are inputted in the trained model M_{T}.

The set of input data Di, comprises:
initial values of each flow parameter P_{F} for the geological reservoir of interest, that is to say an initial value for each region of coordinates (x, y, z) of the geological reservoir, and
a value of each geological feature for each region of space of coordinates (x, y, z) of the geological reservoir.

The artificial intelligence model M is a neural network having neural parameters (also called weights). The training technique enables to approximate the elementary functions fₜ, gₜ (which are unknown) of the physics model Mφ for each timestep by setting the values of the neural parameters for each timestep so that some values are specific for each timestep.

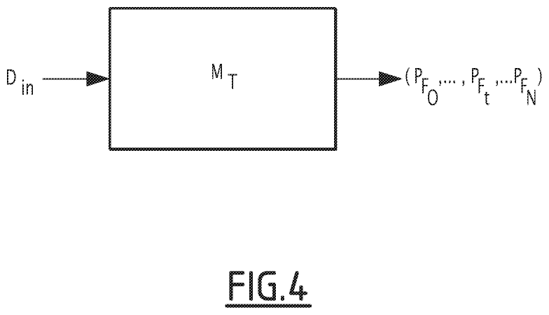

FIG. 3 summarizes the different elements used to train the model M. FIG. 4 summarizes the input and the output of the trained model M_{T}.

Preferably, during the training step, the setting of the values of the neural parameters for each timestep is carried out so that some values are common for all the timesteps.

Preferably, during the training step, the values of the neural parameters are set so as to minimize a cost function. The cost function describes the differences between the spatiotemporal evolutions of flow parameter(s) P_{F} of the training database DB and the corresponding spatiotemporal evolutions of flow parameter(s) P_{F} obtained with the artificial intelligence model M.

Preferably, the artificial intelligence model M is a convolutional neural network.

In an example of implementation, each elementary function is parameterized by neural parameters (weights) fₜ(⋅)=fₜ(W_{ft}), gₜ(⋅)=gₜ(W_{gt}) for t=1 . . . T. The neural parameters [W_{ft}, W_{gt}], for t=1 . . . T completely characterize the elementary functions. This means that the model M is totally defined by the knowledge of these parameters.

Then, in this example of implementation, in order not to have a total number of parameters that increases rapidly with the number of timesteps, a strategy of shared parameters is used: W_{ft}=[W_{f}, w_{ft}], t=1 . . . T, W_{gt}=[W_{g}, w_{gt}], t=1 . . . T. The parameters W_{f}, W_{g} are the same for all the elementary functions fₜ(⋅), gₜ(⋅) for t=1 . . . T. The parameters w_{ft}, w_{gt} are the parameters to be added to construct fₜ(⋅), gₜ(⋅). The total number of parameters w_{ft}, w_{gt} is very small compared to the total number of parameters W_{f}, W_{g}. This strategy allows us to keep a total number of parameters that does not vary greatly with the length of the simulation.

In this example of implementation, the elementary functions fₜ(⋅), gₜ(⋅) are adapted to each time step with their adjustable parameters w_{ft}, w_{gt}. Obtaining the adjustable parameters w_{ft}, w_{gt} is achieved by an optimization. The cost function of this optimization is the following:

$${F}_{cost} = ( observed simulations - model simulations ( {W}_{f} , {W}_{g} , {w}_{ft} , {w}_{gt} ) )$$

The previous cost function measures the difference between simulations obtained from classical methods and simulations made from the model M. During the phase called learning phase the previous optimization will optimize the parameters [W_{f}, W_{g}, w_{ft}, w_{gt}] so that the difference between the observed simulations and the simulations produced by the model M is minimal. The parameters that minimize the cost function noted [W*_{f}, W*_{g}, w*_{ft}, w*_{gt}] are called the model parameters.

In an example of implementation, the architecture of the functions fₜ(⋅), gₜ(⋅) is based on tools such as Inception Resnet, Dense, Max pooling and Upsampling.

For example, the artificial intelligence model M is built on the basis of the Dense-U-Net architecture such as an architecture described in the article Zhang, Z., Wu, C., Coleman, S., & Kerr, D. (2020). DENSE-INception U-net for medical image segmentation. Computer Methods and Programs in Biomedicine.

The person skilled in the art will understand that the training step 120 comprises the effective training of the model M, as well as tests and validation performed on the model M so as to obtain the trained model M_{T}. In particular, during the validation, simulations produced by the trained model M_{T} are compared with simulations produced by classical methods and which have not been included in the cost function. The validation allows to test the generalization of the trained model M_{T}. If the results of this comparison are acceptable according to a well-defined criterion, the trained model M_{T} is ready to be used on new cases. If not, the trained model M_{T} goes back to the previous optimization to improve the results.

The characterization method comprises a step 130 of obtaining a set of input data D, for a geological reservoir of interest. The obtaining step 130 is implemented by the calculator 10 in interaction with the computer program product 12, that is to say is implemented by a computer.

As previously described, the set of input data Dᵢₙ comprises initial values of each flow parameter P_{F} for the geological reservoir, and a value of each geological feature of said geological reservoir of interest for each region of space or grid cell.

The characterization method comprises a step 140 of characterizing the geological reservoir of interest by operating the trained model M_{T} for predicting the spatio-temporal evolution of each flow parameter P_{F} for the geological reservoir of interest on the basis of the obtained set of input data Dᵢₙ. The characterizing step 140 is implemented by the calculator in interaction with the computer program product 12, that is to say is implemented by a computer.

In a first example of implementation, the characterization methods aims at obtaining geological features of the geological reservoir of interest according to the principle of history matching. In this first example of implementation, the characterizing step 140 comprises:
obtaining a measured spatiotemporal evolution of the flow parameters P_{F} for the geological reservoir of interest over the same period of time (past period of time) than the trained model M_{T}, and
repeating the operation of the trained model M_{T} for different values of the geological feature(s) of the geological reservoir of interest in the input data Dᵢₙ until the spatiotemporal evolution of the flow parameters P_{F} obtained with the trained model M_{T} matches the measured spatiotemporal evolution of the flow parameters P_{F}.

In this first example of implementation, the values of the geological feature(s) in the input data Dᵢₙ corresponding to the matching enables to characterize the geological reservoir of interest. For example, the geological features which are obtained are the pressure and/or the saturation of an element in the geological reservoir of interest.

In a second example of implementation, at least a flow parameter P_{F} is a gas saturation. In this second example of implementation, the characterizing step 140 comprises:
repeating the operation of the trained model M_{T} for different values of the geological feature(s) of the geological reservoir of interest in the input data Dᵢₙ, and
evaluating the probability that the gas goes out of the geological reservoir on the basis of the spatiotemporal evolution of said gas saturation obtained for the different values of the geological feature(s). Indeed, this allows to better evaluating the potential geological features of the geological reservoir of interest that would induce a gas escape out of the geological reservoir of interest.

Hence, the characterization method is based on a hybrid technology that mixes Machine Learning (Deep Learning) and physics. Using Deep Learning enables to learn from the observational data at hand. Using physics enables to obtain a Deep Learning model that respects physics.

The obtained trained model M_{T} enables to simulate over long periods of time, while handling complex geologies. In particular, the trained model M_{T} enables to perform dynamic simulations of a petroleum reservoir in a few seconds for a new geological model parameterized by thousands/millions of variables, where the same simulation with a standard reservoir simulator would take several hours. Hence, the trained model M_{T} enables to predict faster and in a reliable way the flow parameters of a geological reservoir of interest.

The person skilled in the art will understand that the embodiments and variants described above can be combined to form new embodiments provided that they are technically compatible.

1. A method for characterizing a geological reservoir of interest, the method comprising the following steps which are computer-implemented:
obtaining a physics model defining a relation between flow parameter(s) of a given geological reservoir at a timestep and flow parameter(s) of the given geological reservoir at the previous timestep for a plurality of timesteps, the physics model being based on elementary functions specific to each timestep so that the flow parameter at a timestep depends on the elementary functions corresponding to said flow parameter at said timestep and on at least the corresponding flow parameter obtained at the previous timestep,
obtaining a training database relative to known possible geological realizations of a given geological reservoir, the training database comprising for each geological realization a set of data comprising:
a past spatiotemporal evolution of flow parameter(s) for said geological reservoir, values of at least one geological feature for said geological reservoir,
training an artificial intelligence model according to a training technique applied to the training database to obtain a trained model, the trained model predicting the spatiotemporal evolution over a period of time of flow parameter(s) for a geological reservoir of interest when a set of input data relative to the geological reservoir of interest are inputted in the trained model, the set of input data comprising initial values of each flow parameter for the geological reservoir of interest and values of each geological feature for said geological reservoir of interest, the artificial intelligence model being a neural network having neural parameters, the training technique enabling to approximate the elementary functions of the physics model for each timestep by setting the values of the neural parameters for each timestep so that some values are specific for each timestep,
obtaining a set of input data for a geological reservoir of interest, and
characterizing the geological reservoir of interest by operating the trained model for predicting the spatiotemporal evolution of each flow parameter for the geological reservoir of interest on the basis of the obtained set of input data.

2. A method according to claim 1, wherein, during the training step, the setting of the values of the neural parameters for each timestep is carried out so that some values are common for all the timesteps.

3. A method according to claim 1, wherein during the training step, the values of the neural parameters are set so as to minimize a cost function, the cost function describing the differences between the spatiotemporal evolutions of flow parameter(s) of the training database and the corresponding spatiotemporal evolutions of flow parameter(s) obtained with the artificial intelligence model.

4. A method according to claim 1, wherein the artificial intelligence model is a convolutional neural network.

5. A method according to claim 1, wherein at least a geological feature of the geological reservoir is chosen among the porosity, the permeability, the net to gross, the fault transmissibility tensor, the residual oil/water saturations and the changes in the boundary conditions related to the well controls.

6. A method according to claim 1, wherein at least a flow parameter is chosen in the group consisting of a fluid saturation, a gas saturation, a fluid pressure and a gas pressure.

7. A method according to claim 1, wherein the physics model is such that the flow parameter at a timestep depends on the corresponding elementary functions at said timestep, on the corresponding flow parameter obtained at the previous timestep and on at least another flow parameters obtained at the previous timestep.

8. A method according to claim 1, wherein at least two flow parameters are considered when implementing the method, the two flow parameters being a saturation and a pressure of an element in the considered geological reservoir, the physics model being described by the following equations:
$$\hat{P} ( Δ t , x , y , z , m ) = \hat{P} ( Δ t - 1 , x \pm Δ x , y \pm Δ y , z \pm Δ z , m ) - {g}_{t} ( m , \hat{P} ( Δ t - 1 , x \pm Δ x , y \pm Δ y , z \pm Δ z , m ) , \hat{S} ( Δ t - 1 , x \pm Δ x , y \pm Δ y , z \pm Δ z , m ) )$$
$$\hat{S} ( Δ t , x , y , z , m ) = \hat{S} ( Δ t - 1 , x \pm Δ x , y \pm Δ y , z \pm Δ z , m ) - {f}_{t} ( m , \hat{P} ( Δ t - 1 , x \pm Δ x , y \pm Δ y , z \pm Δ z , m ) , \hat{S} ( Δ t - 1 , x \pm Δ x , y \pm Δ y , z \pm Δ z , m ) )$$
$$P ( Δ {t}_{0} , x , y , z , m ) = P 0$$
$$S ( Δ {t}_{0} , x , y , z , m ) = S 0$$
Where:
m corresponds to the geological features of a geological reservoir,
\hat{P}(Δt, x, y, z, m) is the predicted pressure of the element at timestep Δt in the region of space defined by the spatial coordinates (x, y, z) for a geological reservoir having the geological features m,
\hat{P}(Δt−1, x±Δx, y±Δy, z±Δz, m) is the predicted pressure of the element at timestep Δt−1 in the region of space defined by the spatial coordinates (x±Δx, y±Δy, z±Δz) for a geological reservoir having the geological features m,
Ŝ(Δt, x, y, z, m) is the predicted saturation of the element at timestep Δt in the region of space defined by the spatial coordinates (x, y, z) for a geological reservoir having the geological features m,
Ŝ(Δt−1, x±Δx, y±Δy, z±Δz, m) is the predicted saturation of the element at timestep Δt−1 in the region of space defined by the spatial coordinates (x±Δx, y±Δy, z±Δz) for a geological reservoir having the geological features m,
P0 is the pressure of the element at the initial timestep Δt₀ in the region of space defined by the spatial coordinates (x, y, z) for a geological reservoir having the geological features m,
S0 is the saturation of the element at the initial timestep Δt₀ in the region of space defined by the spatial coordinates (x, y, z) for a geological reservoir having the geological features m,
gₜ is an elementary function at timestep Δt for the pressure, and
fₜ is an elementary function at timestep Δt for the saturation.

9. A method according to claim 1, wherein each set of data of the training database are simulated data obtained using a simulator based on partial differential equations.

10. A method according to claim 1, wherein the characterizing step comprises:
obtaining a measured spatiotemporal evolution of the flow parameters for the geological reservoir of interest over the same period of time than the trained model, and
repeating the operation of the trained model for different values of the geological feature(s) of the geological reservoir of interest in the input data until the spatiotemporal evolution of the flow parameters obtained with the trained model matches the measured spatiotemporal evolution of the flow parameters,
the value(s) of the geological feature(s) in the input data corresponding to the matching enabling to characterize the geological reservoir of interest.

11. A method according to claim 1, wherein at least a flow parameter is a gas saturation, the characterizing step comprising:
repeating the operation of the trained model for different values of the geological feature(s) of the geological reservoir of interest in the input data, and
evaluating the probability that the gas goes out of the geological reservoir on the basis of the spatiotemporal evolution of said gas saturation obtained for the different values of the geological feature(s).

12. (canceled)

13. A readable information carrier on which a computer program product is stored, the computer program causing execution of the steps of a method according to claim 1 when the computer program is carried out on a data processing unit.
